(19) United States
(12) Patent Application Publication
(10) Pub. No.: US 2007/0193858 A1
(43) Pub. Date: Aug. 23, 2007

(54) Reciprocating conveyor system and method

(75) Inventors: Kevin D. Hillstrom, Loretto, MN (US); John M. Zanetti, Arkansaw, WI (US); Ralph D. Burgess JR., Plymouth, MN (US)

Correspondence Address: JASON R. FULMER, IP SECTION;GARDERE WYNNE SEWELL LLP, 3000 THANKSGIVING TOWER, 1601 ELM STREET, SUITE 3000, DALLS, TX, 75201, US

(73) Assignee: TRIPLE/S DYNAMICS, INC., DALLAS, TX (US)

(21) Appl. No.: 11/359,085

(22) Filed: Feb. 22, 2006

(51) Int. Cl. B65G 27/00

(52) U.S. Cl. 198/752.1

(57) ABSTRACT

A linear reciprocating conveyor system includes an elongated tray connected to a linear electric motor, the tray and motor each being supported on linkages allowing linear reciprocating motion without transferring vibration to system support structure. The linear electric motor is adapted for control by a method which provides a current profile to effect reciprocation of the motor to convey articles or material with the tray in one direction and acceleration of the tray in the opposite direction to provide slippage of the material or articles, thus causing the material or articles to move toward a tray discharge end. The motor armature may be supported with respect to the motor stator by an air bearing system. Plural motors may be connected to the tray and also supported by an air bearing system.

### BACKGROUND OF THE INVENTION

In the art of conveyor systems for transferring solid materials and articles, oscillating conveyors are known which are generally characterized as reciprocating conveyors and vibrating conveyors. Both types of conveyors of the general type use known components and apparatus which require frequent maintenance, due at least in part to the nature of the motion of the conveyor system and friction generated by the drive mechanism.

Oscillating or reciprocating tray or pan conveyors are known which are driven by linear motors which attempt to initiate the conveying acceleration at a particular range of acceleration forces and then, during a further portion of a conveyance cycle, the acceleration increases to a value close to the so-called slip acceleration rate. Known types of linear motors are difficult to control to produce a high enough acceleration of the conveyor tray or pan on the slip portion of the cycle so as to easily exceed the coefficient of friction between the material or article being conveyed and the conveyor pan or tray surface while also maintaining acceleration low enough to minimize adverse stresses on the conveyor system.

Moreover, desirable rates of acceleration in the conveying portion of the conveyor operating cycle, as well as in the slip portion of the cycle, have been difficult to achieve heretofore. For example, a desirable system is one which, in the advancing of the material or article portion of the cycle, the conveying velocity is maximized with a minimum of slippage while, during the slippage portion of the cycle, the tray or pan returns to the cycle starting point with negligible movement of the conveyed material or articles in a direction opposite to that desired.

It is to overcome the deficiencies of prior art conveyors and drive systems therefor and to meet the desiderata discussed herein, as well as other improvements in the art of reciprocating or oscillatory conveyors, that the present invention has been developed.

### SUMMARY OF THE INVENTION

The present invention provides an improved reciprocating or oscillating type conveyor system for conveying solid materials and articles along a conveyor tray in a generally horizontal and linear direction. The conveyor system of the invention provides for conveyance of articles with minimal generation of vibration transferred to the system support structure and with minimal generation of frictional heat within the system and its components.

In accordance with one aspect of the present invention a reciprocating conveyor is provided which includes an elongated conveyor tray supported for horizontal reciprocating movement to advance articles or solid materials, such as food packages or the like, along the length of the conveyor structure, said conveyor structure, comprising an elongated channel shaped tray, being connected to a linear reciprocating electric drive motor which provides essentially true reciprocating motion. The drive motor and conveyor tray are mounted aligned with each other for movement linearly along a horizontal path on straight line support linkages or supported on a horizontal linear air bearing system.

In accordance with another aspect of the invention, a conveyor system is provided wherein a linear electric motor is connected to a conveyor tray at one end thereof to oscillate the tray typically at a rate of about 100 to 300 cycles per minute. The intended direction of movement of material or articles being conveyed is achieved by moving the tray slowly in one direction and then returning the tray in the opposite direction at a rate which allows slippage of the material or articles so that it continues to move in the intended direction while the tray or pan moves in an opposite direction.

The present invention further provides a linear conveyor system utilizing a linear electric motor having an improved control system including a processor which may be programmed to provide the desired motion of the conveyor system.

The present invention still further provides an improved method of operating a reciprocating conveyor system driven by an electric motor wherein the motor is controlled in a manner which provides improved conveyance of the material or articles to be conveyed.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

FIG. 1 is a perspective view of an improved reciprocating or oscillating conveyor system in accordance with the invention;

FIG. 2 is a longitudinal side elevation of the conveyor system shown in FIG. 1;

FIG. 3 is an end elevation of the conveyor system shown in FIG. 1 taken generally from the line 3-3 of FIG. 2;

FIG. 4 is a detail side elevation of one embodiment of a linear motor and an associated conveyor pan or tray in accordance with one preferred embodiment of the invention;

FIG. 5 is a detail transverse section view of the motor armature;

FIG. 6 is a side elevation in somewhat schematic form of another preferred embodiment of a reciprocating conveyor system in accordance with the invention;

FIG. 7 is a longitudinal central section view of a preferred embodiment of a linear motor for the conveyor systems in accordance with the invention;

FIG. 8 is a detail section view taken generally from the line 8-8 of FIG. 6;

FIG. 9 is a block diagram of a control system for the conveyor systems of the present invention;

FIG. 10 is a diagram illustrating displacement and acceleration of the conveyor tray during one cycle of operation; and

FIG. 11 is a diagram illustrating the current imposed on the conveyor drive motor during one cycle of operation.

### DETAILED DESCRIPTION OF THE PREFERRED EMBODIMENTS

In description which follows like parts are marked throughout the specification and drawing with the same reference numerals, respectively. The drawing figures are not necessarily to scale and certain features may be shown in generalized or schematic form in the interest of clarity and conciseness.

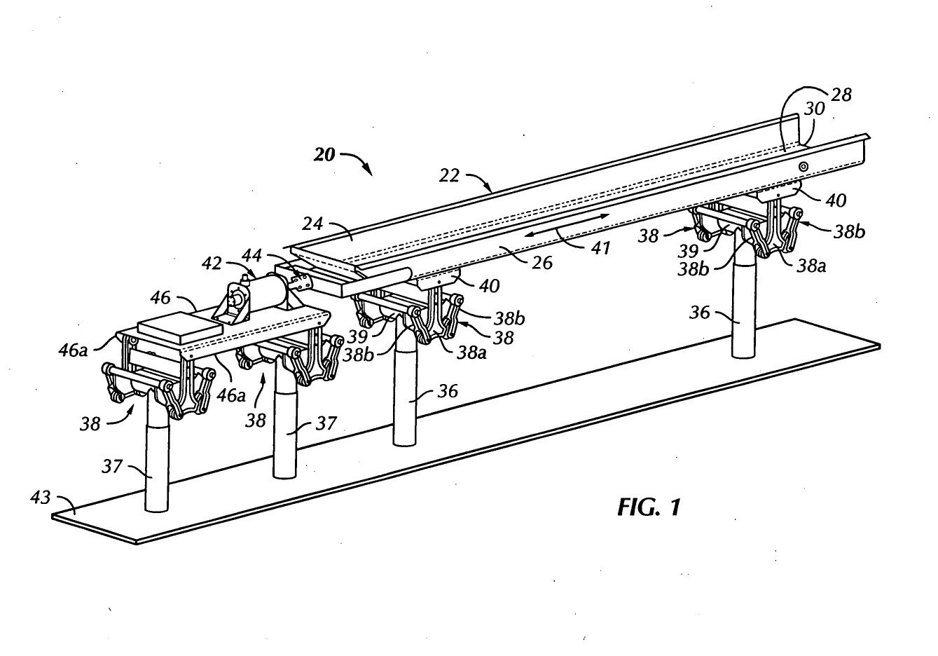

Referring now to FIGS. 1 through 3, there is illustrated one preferred embodiment of a substantially horizontal reciprocating conveyor system in accordance with the invention and generally designated by the numeral 20. The conveyor system 20 is characterized by an elongated, relatively shallow, channel shaped pan or tray member 22 comprising opposed sidewalls 24 and 26, a generally flat, horizontal bottom wall 28 and an open discharge end 30. The material inlet portion of the conveyor tray 22 includes a substantially closed end provided by a transverse wall 32. A somewhat yoke shaped actuator bracket member 34 is suitably connected to the tray 22 at the end having the closure or end wall 32 formed thereon, as illustrated.

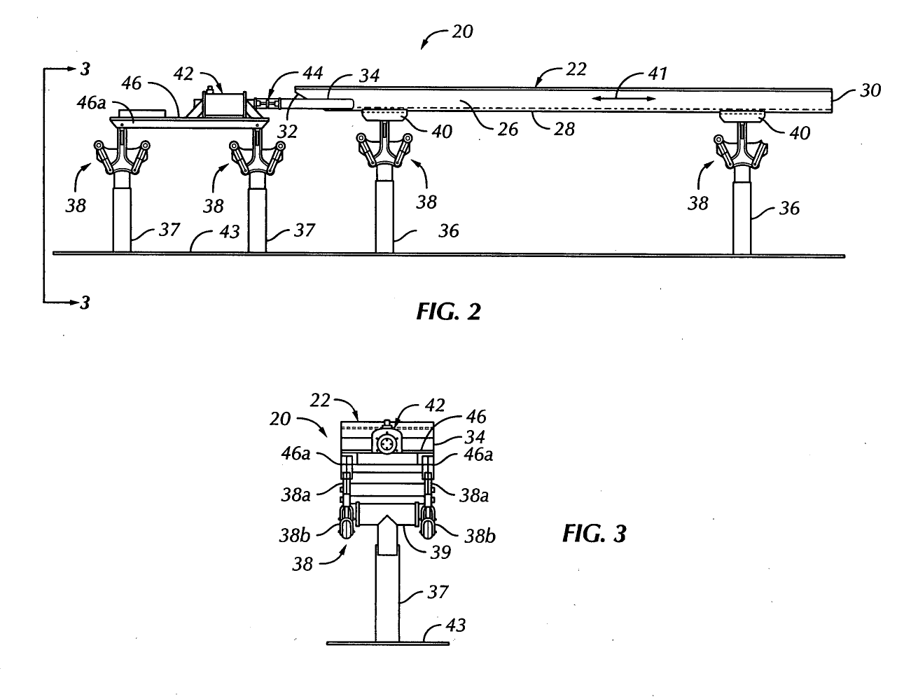

The conveyor tray 22 is mounted on spaced apart upstanding pedestals 36 although other structure may be adapted to support the tray. Pedestals 36 have respective tray support linkage assemblies 38 mounted thereon, such linkage assemblies also being connected to depending tray support brackets 40 spaced apart, as illustrated. The linkage assemblies 38 each include opposed center links 38a connected to the bracket 40 on opposite ends thereof and respective connecting links 38b supported on a linkage frame 39. The links 38a and 38b may be connected to the brackets 40 and the linkage frame 39 and to each other by suitable elastomer bushings. In particular, the linkage assemblies 38 are preferably constructed in accordance with those disclosed in U.S. Pat. Nos. 5,392,898; 5,460,259 and 5,584,375 to Burgess, Jr., et al. and issued on Feb. 28, 1995, Oct. 24, 1995 and Dec. 17, 1996, respectively. The subject matter of U.S. Pat. Nos. 5,392,898; 5,460,259 and 5,584,375 is incorporated herein by reference, respectively. An important advantage of the linkage assemblies 38 is one wherein the linkage assemblies permit linear reciprocating motion of the tray 22 generally in the direction of the arrow 41 in FIGS. 1 and 2, respectively. The reciprocating path of movement of the tray 22 may be substantially horizontal or inclined at predetermined angles either with discharge end 30 extending in an upward direction with respect to the inlet end closed by wall 32, or extending in a generally downward direction.

The reciprocating conveyor tray 22 is advantageously connected to a linear reciprocating motor, generally designated by a numeral 42. Motor 42 is operably connected to the yoke 34 by a suitable coupling 44 for imparting reciprocating motion to the tray 22. Motor 42 is of a type to be described in further detail herein and is shown mounted on a suitable support platform 46. Platform 46 is also mounted on spaced apart linkages assemblies 38 in the same manner that the tray 22 is mounted. The linkage assemblies 38 supporting the motor platform or frame 46 are also supported on spaced apart upstanding columns 37 similar to the columns 36. Motor support 46 is characterized as a generally planner plate-like member with opposed depending flanges 46a, FIGS. 1 and 3, to which are connected the links 38a of the respective linkage assemblies 38, as shown. Accordingly, both the motor 42 and the conveyor tray 22 are mounted for linear reciprocating motion and the linkage assemblies 38 minimize the transfer of vibrations to the columns 36 and 37 and to a floor or support for such columns, indicated by numeral 43 in FIGS. 1 through 3.

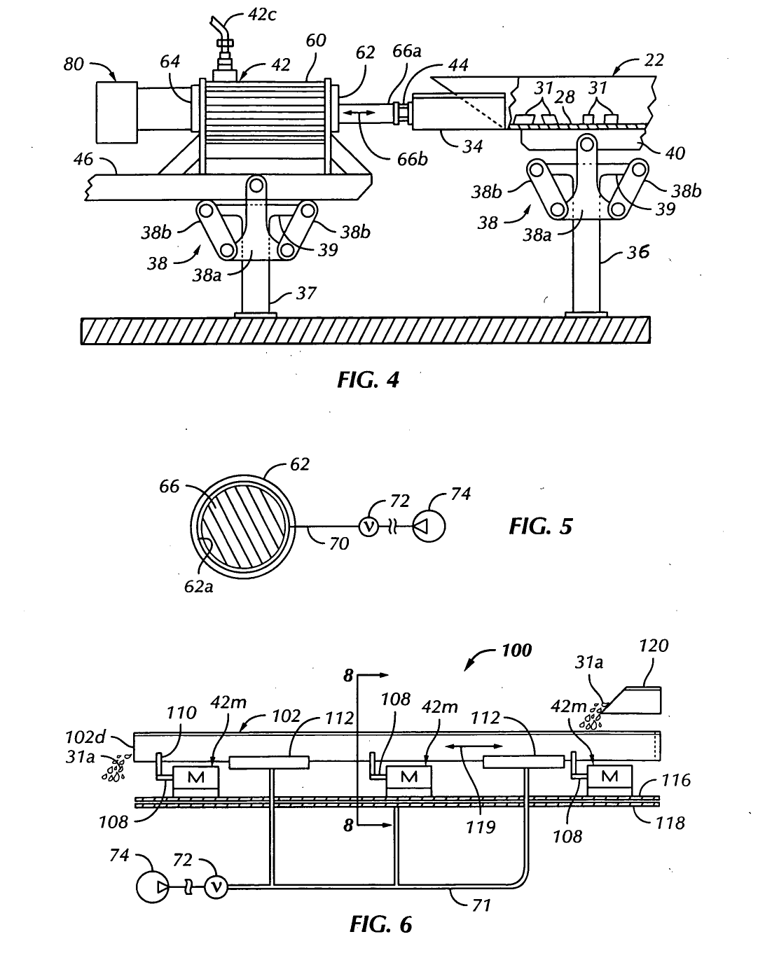

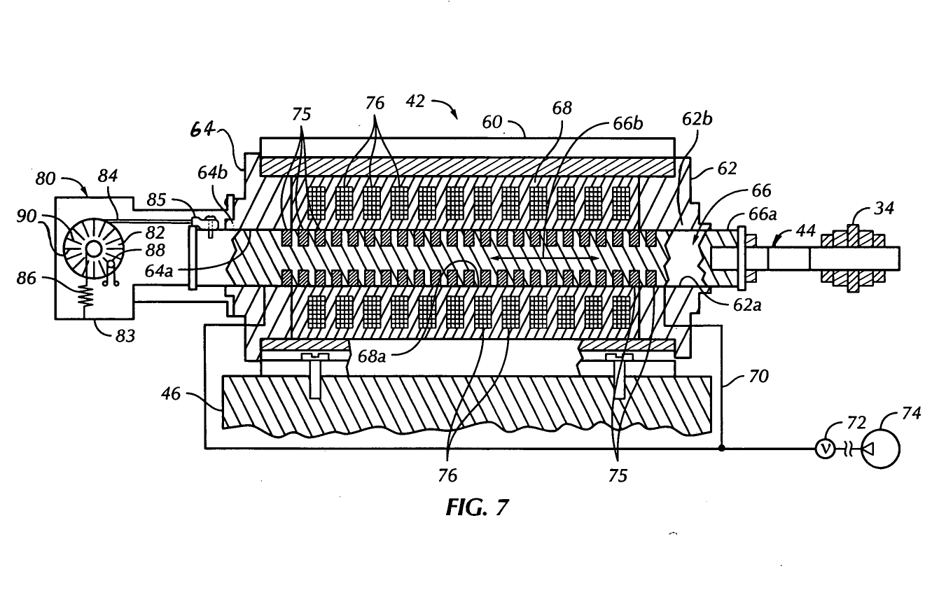

Referring now to FIGS. 4, 5 and 7, the reciprocating linear motor 42 is illustrated in some additional detail. The motor 42 is characterized by an outer housing 60 of generally cylindrical configuration and opposed end parts 62 and 64, FIG. 7, which preferably include armature bearing portions 62b and 64b. An elongated generally cylindrical armature 66 is disposed for reciprocation in the housing 60, 62, 64 in respective bearing bores 62a and 64a. One end 66a of armature 66 is connected to the coupling 44 between the armature and the tray 22 by way of the yoke 34.

Referring further to FIG. 7, the motor 42 also includes a generally cylindrical stator member 68 having a central bore 68a in close fitting relationship to the armature 66, but allowing free reciprocating sliding motion which is also provided by the housing end members 62 and 64 since the armature 66 is disposed for free sliding movement within the bearing bores 62a and 64a. The motor 42 is preferably provided with an air bearing system for minimizing friction and providing free sliding relationship of the armature 66 with respect to the housing end parts 62 and 64 and the stator 68. Pressure air may be supplied to the bearing bores 62a, 64a and bore 68a by way of a conduit system 70, see FIGS. 5 and 7, which conduit system is connected to a suitable pressure regulator control valve 72 and a source of pressure air comprising a compressor 74. Other arrangements of bearings for allowing free reciprocating motion of the armature 66 in the direction of the double-headed arrow 66b, FIGS. 4 and 7, may be provided. However, an air bearing arrangement for support of the armature 66 is desirable.

The exemplary and advantageous motor 42 is further characterized, as shown in FIG. 7, by plural spaced apart permanent magnets 75 which are spaced along a major portion of the overall length of the armature 66. The stator 68 is provided with longitudinally spaced electro magnets 76, also as shown in FIG. 7. It should be noted that the motor 42 is aligned axially with conveyor tray 22 so that reaction forces due to movement of the tray 22 and the motor 42 will not be transferred to the supporting structure or the floor or platform on which the conveyor system 20 is mounted, thanks, at least in part, to the linkage assemblies 38 which support the conveyor system.

Referring further to FIG. 7, the motor 42 is provided with a so-called feedback assembly 80 adapted to provide a pulse generator, an output signal from which is utilized in a control system to be described in further detail herein. The pulse generator may include, for example, a rotatable slotted wheel 82 suitably mounted for rotation within a housing 83 connected to the motor housing end part 64, for example. Rotatable wheel 82 is connected via a flexible link 84 to the armature 66 at a suitable bracket 85. Pulse generator wheel 82 is also biased to rotate in one direction by a spring motor 86. A suitable optical sensor 88, for example, is disposed in proximity to the wheel 82 and generates suitable pulse type signals as the wheel rotates and circumferentially spaced apart radially extending slots or markings 90 pass in proximity to the sensor 88. Thus, a suitable pulse type signal is generated by the so-called feedback assembly 80 which is correlated with the direction of movement, position and velocity of the armature 66 and the tray 22 for use in controlling operation of the motor 42 as will be described in further detail herein. For example, the armature 66 may be controlled to move a certain distance with a prescribed velocity and acceleration for each position of the armature measured by the feedback assembly 80 for use by the aforementioned controller. Electric power is supplied to the motor 42 by way of a suitable conductor assembly 42c, FIG. 4.

Referring briefly to FIGS. 6 and 8, another embodiment of a conveyor system in accordance with the invention is illustrated and generally designed by the numeral 100. The conveyor system 100 also utilizes an elongated, generally rectangular, channel-shaped pan or tray 102 similar in some respects to the tray 22 and comprising a generally planar bottom wall 103, and opposed upstanding sidewalls 104 and 106, FIG. 8. In the embodiment shown somewhat schematically in FIGS. 6 and 8, the elongated material conveying tray 102 is at least partially supported by and connected to plural spaced apart linear motors 42m which are mounted on opposite sides of the tray 102 and are each provided with an armature 108 connected by a coupling 110, respectively, to the respective tray sidewalls 104 and 106, as illustrated. Motors 42m are similar in most respects to the motor 42. Tray 102 is also supported above a suitable bearing plate 112, FIGS. 6 and 8, which plate is provided with opposed side edge flanges 112a and 112b. A source of pressure air, such as a compressor 74, is adapted to supply pressure air to a space between tray bottom wall 103 and bearing plate 112 to assure that a suitable pressure fluid lubricant is provided to such space to assist in suspending the tray 102 above the surface of the bearing plate 112 during operation of conveyor 100. FIG. 6 illustrates somewhat schematically, two spaced apart bearing plates 112 for supporting tray 102 and being furnished with pressure air via conduit system 71 connected to a control valve 72 and compressor 74.

Referring further to FIGS. 6 and 8, motors 42m are also supported on an air bearing system including a generally planner bearing plate member 116 which is operable to be levitated above a bearing plate 118 and also supplied with pressure air via the conduit system 71, control valve 72 and compressor 74, as illustrated. Accordingly, a conveyor tray or pan such as the tray 102 may be oscillated or reciprocated in the direction of the double-headed arrow 119 in FIG. 6 whereby material may be dispensed from a source 120 onto the conveyor 100 and conveyed toward a discharge end of the tray 102 as indicated at 102d. The motors 42m are aligned with tray 102 for imparting reciprocation to the tray and the motors will, of course, be operated in synchronization with each other to provide the linear reciprocating motion in the direction of the double-sided arrow 119, FIG. 6. Vibrations will, essentially, not be transferred to any support structure for the bearing plate 118 thanks, at least in part, to the air bearing arrangement provided by the support plate 116, and the air bearing support plate 118 as well as the configuration of the tray 102 and its support by the bearing plates 112. Each of the motors 42m may be provided with a feedback assembly similar to the feedback assembly 80 described hereinabove for the motor 42.

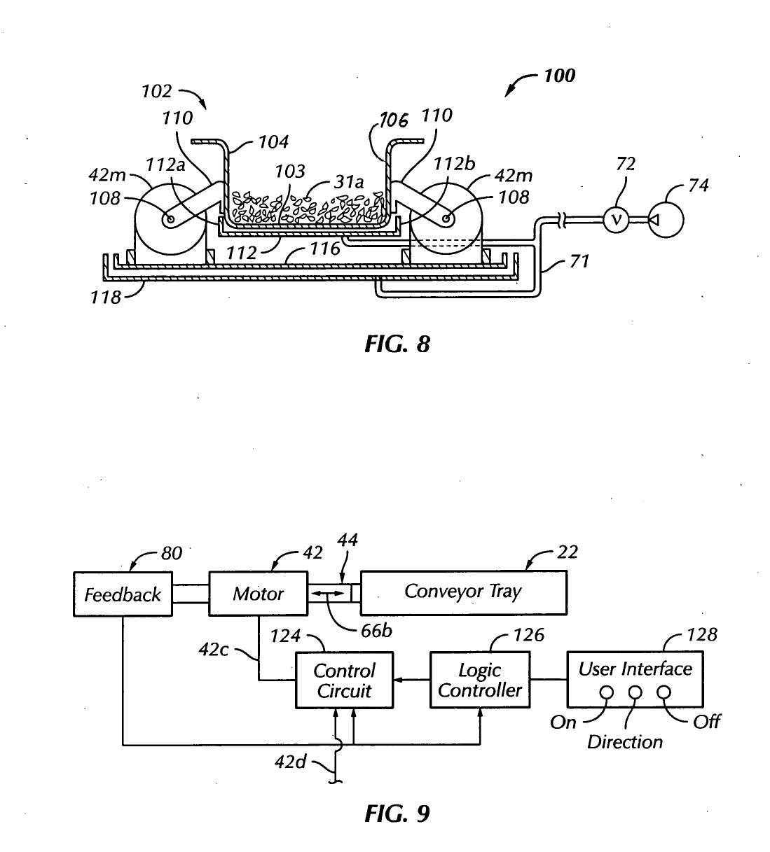

Referring briefly to FIG. 9, there is illustrated a schematic diagram of the conveyor tray 22, the motor 42, the coupling 44 between the motor and the conveyor tray, the feedback assembly 80 and also showing connections to a motor control circuit 124, a logic controller 126 and a user interface 128. The controller 126 may be a suitable programmable microprocessor for carrying out commands to the motors 42 or 42m based on signals received through the feedback assembly 80 and in response to selected commands given by an operator of the conveyor systems 20 or 100 through the user interface 128. Since the feedback assembly 80 is operable to provide signals indicating the position of the motor armature 66 and thus the position of the conveyor pan or tray 22, for example, which position signals may be used to determine velocity and acceleration limits, the controller 126 may, through the control circuit 124, provide commands to control motor armature movement.

For example, the motor feedback assembly 80 may provide a pulse type signal in the range of about 1480 pulses per inch of movement of the armature 66. If the conveyor tray 22 is reciprocated at a rate of about 240 cycles per minute, the stroke of the armature 66 can be varied from about 1.0 inches to about 4.0 inches, by way of example. In a preferred operating mode of the feedback assembly 80, it may be assumed that the armature 66 is to move 0.125 inches in a predetermined period of time. Since the encoder wheel 82 produces 1480 pulses per inch, 185 pulses correspond to 0.125 inches of armature movement. The pulse signals are transmitted from the encoder or feedback assembly 80 to the controller 126 via suitable conductors and circuitry within the controller 126 may count the pulse signals to determine the position, velocity and acceleration of the motor armature 66 and the conveyor tray 22. Accordingly, when the armature 66 is to be accelerated a control program residing in the controller 126 may be set to count a greater number of counts per unit time and to achieve this, the control circuitry provides a proportionally greater current to the motor 42 from a source, not shown, via conductor 42d, control circuit 124 and conductor 42c resulting in the desired count per unit of time.

In order to achieve the conveyance of material, such as articles 31, FIG. 4 or particulate material 31a, FIG. 8 it has been determined that the current used to drive the motor 42 should have a somewhat alternating wave form to achieve suitable conveying velocities. If material or articles to be conveyed by the pan or tray 22 are to be moved in the direction to the right, viewing FIG. 2, toward the discharge end 30 of the conveyor 20, then movement of the tray 22 should be such as to carry the material or articles with the tray when moving to the right, but when the tray or pan reverses direction and moves to the left, the acceleration of the tray should exceed the static friction coefficient between the material or articles and the tray surface so that the bottom wall 28 of the tray 22, for example, moves relative to the material or articles toward the left. On the next cycle of reciprocation, that is with the tray 22 moving to the right, viewing FIGS. 2 and 4, the acceleration or velocity should be such, again, as to not exceed the coefficient of friction, thus carrying the material or articles in the intended direction. Repeated cycles of reciprocation of the tray 22, thus advances the material or articles along the bottom wall 28 toward the tray discharge end 30. Of course, the velocities and accelerations of the conveyor systems 20 and 100 should be such as to provide for slippage of the pan or tray relative to the material or articles being conveyed, that is the slip portion of a cycle to exceed the coefficient of friction between the material or articles and the tray bottom wall, but such accelerations are required to be low enough as to not exceed desired mechanical stress levels in the conveyor system.

In accordance with a preferred method of operation of the conveyor systems 20 or 100, once the material or articles to be conveyed has its own moment of inertia, the acceleration is increased to achieve the maximum conveying velocity for the material or articles being conveyed with a minimum of slippage. Accordingly, during the slip portion of an operating cycle of the conveyor system 20 or 100 high acceleration, in a range of about three times the acceleration of gravity (g), would typically far exceed the static friction coefficient between the tray bottom wall and the material or article being conveyed, but would be within the allowable stress limits for the conveyor system. However, during the conveyance portion of the system operating cycle, low acceleration in the range of 1.0 g, would be set to not exceed the coefficient of friction but this acceleration could be increased while staying below that which would create slippage and, at close to maximum displacement of the tray 22 or 102 deceleration should be initiated within allowable stress limits.

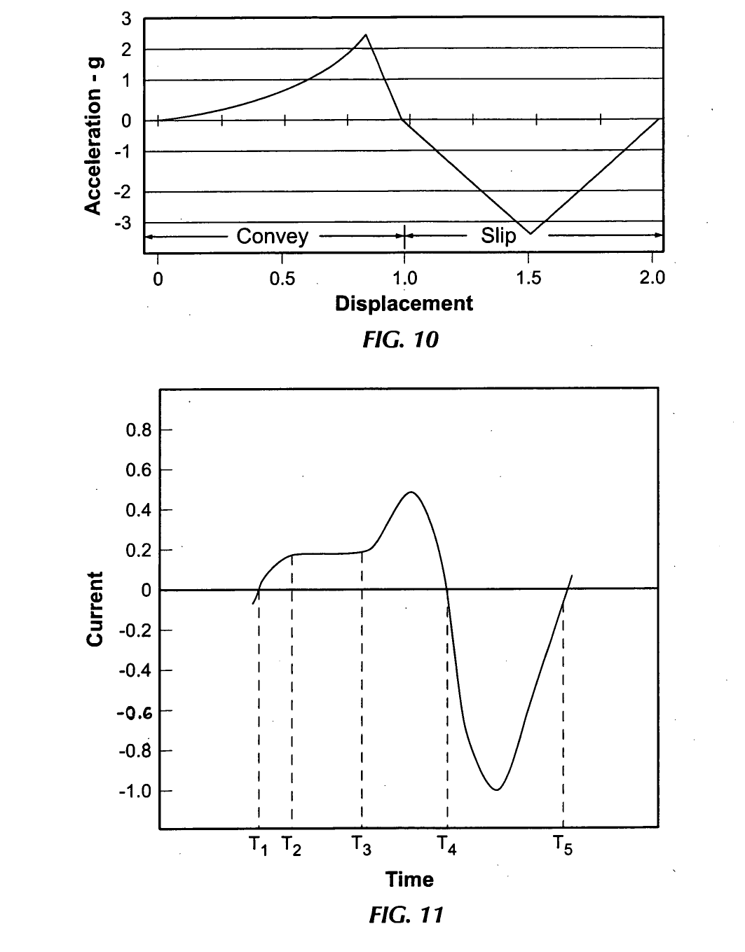

Referring to FIG. 10, there is illustrated a diagram of acceleration versus displacement for a total stroke motor cycle of one inch displacement in each direction of movement of the motor armature 66. As shown in FIG. 10, commencing at zero displacement of the armature 66 and movement to the right, viewing drawing FIG. 2 or 7, an acceleration from 0.0 g to about 1.0 g in the convey portion of the cycle is accomplished at a displacement of about 0.6 inches and in a time of about 56 milliseconds, for example. The acceleration is then increased to about 2.7 gs at 0.85 inches displacement in a time of 28 milliseconds. The pan or tray 22 is then decelerated to 0.0 g at 1.0 inches displacement in a time of about 17 milliseconds. Accordingly, the convey portion of a cycle of operation of the conveyor system 20 or 100 has a total displacement of 1.0 inches in 101.0 milliseconds.

Referring further to FIG. 10, in the slip portion of the cycle at 0.5 inches displacement an acceleration of 3.3 g is reached in a time of about 28 milliseconds and the tray 22, for example, is then decelerated to 0.0 g in another 0.5 inches displacement in a time of about 56 milliseconds. The operating cycle is then repeated.

This asymmetrical displacement versus acceleration of the pan 22 is accomplished by the aforedescribed control system and a current imposed on the motor stator windings or electromagnets 76 to achieve the resulting displacement of the armature 66. For example, referring to FIG. 11, there is illustrated a plot of current versus time to achieve the displacement and acceleration characteristics illustrated in FIG. 10. FIG. 11 is a plot indicating at T1, a current imposed on the motor 42 to urge the armature to move to the right, viewing FIG. 2 or 7, for conveying material or articles with the tray 22 also to the right. Accordingly, during a time period T1 to T2, current is increased to the relative value indicated in the diagram to initiate acceleration of the conveyor tray 22 or 102. As mentioned above, in the initial conveying phase of movement of the conveyor tray, it is important that the tray does not accelerate fast enough to exceed the static coefficient of friction between the tray and the material or articles being conveyed but the tray will carry the material or articles in the direction of movement of the tray.

It has been determined that this action can be accomplished after an initial increasing of current by a second phase of operation of a cycle by holding the current relatively constant for a period of time T2 to T3, FIG. 11. During this phase of operation the current imposed on motor 42 or motors 42m may in fact be decreased slightly, but assurance must be that the tray 22 or 102 will not accelerate enough to slip with respect to the material or articles being conveyed. Once the material or articles have been accelerated and are moving with the tray, a somewhat pulse-like increase in current followed by a decrease to zero of current imposed on the stator electromagnets 76 is carried out in accordance with the characteristic shown in FIG. 11. This current pulse is indicated between time periods T3 and T4. The current pulse that occurs between time T3 and T4 takes advantage of the momentum gained by the material or articles being conveyed which occurred when the current was applied in the manner shown between periods T1 to T3.

Lastly, a pulse of current of opposite polarity is imposed on the electromagnets 76 of motors 42 or 42m, as indicated between times T4 and T5, FIG. 11, to reverse the direction of movement of the tray 22 or 102 so as to create slippage of the material or articles being conveyed due to the reverse acceleration of the tray exceeding the coefficient of static friction between the tray bottom wall surface and the articles or material. In this way, the control system for the conveyor systems of the invention provides a relatively low amplitude forward current characteristic to begin with to accelerate the tray and the material or articles being conveyed without slippage, and the material or articles is then accelerated further without slippage, taking advantage of momentum gained in the initial phase. Then, the reverse direction of movement of the tray 22 or 102 is carried out with greater acceleration and shorter duration, again without unduly stressing the mechanical components of the conveyor system.

For a linear motor 42 of a type described hereinbelow, a force of about 1500 pounds of thrust may be obtained with the relative amplitude of motor current as shown in FIG. 11. From tests carried out on a conveyor system generally in accordance with the description herein a preferred upper limit for acceleration is about 3.0 g to 3.3 g. This provides a possibly effective conveyance operation without imposing unacceptable mechanical stresses on the conveyor system. Of course, the forces and associated currents imposed on the system may vary according to parameters including the mechanical limits of the system, but the general overall profile of acceleration versus displacement and current versus time should be according to the profiles illustrated in FIGS. 10 and 11, respectively.

As mentioned previously, while the conveyer trays 22 or 102 are usually operated in a generally horizontal position, they can also be inclined upwardly at an angle of about 3.0 degrees to the horizon, that is with the discharge end of the conveyor being higher than the inlet end. This an advantage where plural conveyor trays are arranged seriatim. Accordingly, horizontal in the sense intended herein would include at least an incline of the amount referenced. It is also indicated that for a movement of about 1.0 inches in one direction of the tray 22, that displacement of material and/or articles may be as much as 1.20 inches. Since the coefficient of sliding friction is less than static friction. Although the mass of the motor 42 may be varied, it is preferred that the mass of the motor and supporting components connected to the motor be equal to or greater than the mass of the tray 22. Increasing the mass of the motor 42 and associated components will result in further displacement of the tray for a given total displacement of the armature 66. It is indicated that a motor assembly/tray mass ratio of about 1.8:1.0 may be preferred, but a mass ratio of from 1.0:1.0 to about 10.0:1.0 may also be considered to be generally satisfactory. The tray 22 may be formed of a suitable engineering metal or plastic. The motors 42 and 42m including feedback control may be of a type commercially available, such as from California Linear Devices of Carlsbad, Calif., as their Model No. 50206C08T-LCB-CV and including their control integration system no. IP-IC.

As mentioned previously an important advantage of the conveyor system of the invention is that little vibration is transferred to supporting structure or to a floor or platform on which the conveyor system is mounted. The conveyor systems 20 and 100 are mechanically uncomplicated since, in particular, the motors 42 or 42m are provided with, essentially, only one moving part. Still further, movement of the armature 66 is programmed by the control system illustrated and described, for example, to provide a drive current profile generally as shown in FIG. 11 that optimizes conveying efficiency. Moreover, the conveyor systems 20 and 100 may be dynamically balanced since the motor and tray may move in opposite directions essentially at all times thus providing for little or no vibration to be transmitted. Still further, the air bearings described for the conveyor systems 20 and 100 are advantageous for minimizing generation of heat of friction, motor and tray stress and for providing for the desired acceleration characteristic.

Except as otherwise described herein, conventional engineering materials and components may be utilized to construct the conveyor systems 20 and 100. Moreover, although preferred embodiments of the invention have been described in detail, those skilled in the art will recognize that various substitutions and modifications may be made without departing from the scope and spirit of the appended claims.

What is claimed is:

1. A reciprocating conveyor system for conveying one of material and articles generally linearly along a conveyor path, said conveyor system comprising:
an elongated conveyor tray including a bottom wall providing a support surface for said one of said material and articles;
support means for said tray for permitting linear reciprocating motion of said tray to convey said one of said articles and material along said tray toward a discharge end of said tray;
a linear motor operably connected to said tray for imposing reciprocating linear motion of said tray; and
a control system operably connected to said motor for effecting movement of said tray at a rate of acceleration in one direction which minimize slippage between said one of said material and articles and said tray while causing acceleration of said tray in another direction which will effect slippage of said one of said material and articles with respect to said tray to convey said one of said material and articles toward said discharge end.

2. The conveyer system set forth in claim 1 wherein:
said linear motor is mounted on support means allowing substantially linear displacement of said motor in a direction related to the direction of movement of said tray.

3. The conveyor system set forth in claim 2 wherein:
said support means for said tray comprises a linkage system allowing for linear reciprocating motion of said tray.

4. The conveyor system set forth in claim 3 wherein:
said motor is mounted on a motor linkage system providing for linear reciprocating motion of said motor in a direction aligned generally with the direction of linear reciprocating motion of said tray.

5. The conveyor system set forth in claim 4 wherein:
the mass of said motor and supporting components supported by said motor linkage system is in a range of about 1.0 to 10.0 times the mass of said tray.

6. The conveyor system set forth in claim 1 wherein:
said linear motor comprises a linear electric motor including an armature operably connected to said tray and a stator mounted on support means for said motor.

7. The conveyor system set forth in claim 6 wherein:
said control system is operable to impose a current on said motor to effect reciprocating motion of said armature and said tray at a predetermined rate of acceleration in one direction and at another predetermined rate of acceleration in an opposite direction of movement of said tray to effect conveyance of said one of said materials and articles with said tray in said one direction and to provide slippage of said tray with respect to said one of said material and articles in said opposite direction.

8. The conveyor system set forth in claim 7 wherein:
said control system is operable to provide during a first period of time an increasing current to said motor to a predetermined amount followed by a relatively constant or decreasing current to said motor during a second period of time followed by a changing current during a third period of time and followed by another changing current of an opposite polarity during a fourth period of time to effect movement of said one of said material and articles along said tray.

9. The conveyor system set forth in claim 1 wherein:
said motor includes an armature and a stator, bearing means for supporting said armature with respect to said stator, said bearing means comprising a pressure air bearing for suspending said armature on a layer of pressure air during reciprocation thereof.

10. The conveyor system set forth in claim 1 wherein:
said support means for said tray comprises an air bearing including a bearing member supporting said tray and a source of pressure air for causing said tray to be suspended relative to said bearing member on a layer of pressure air.

11. The conveyor system set forth in claim 1 wherein:
said linear motor comprises plural spaced apart linear motors each operably connected to said tray for effecting reciprocating linear movement of said tray.

12. The conveyor system set forth in claim 11 wherein:
said plural linear motors are disposed on opposite sides of said tray and operably connected thereto, said plural linear motors being controlled to operate in synchronization with each other to impart linear reciprocating movement to said tray.

13. The conveyor system set forth in claim 11 including:
an air bearing system including a first air bearing member, and a second air bearing member for supporting said motors and said tray relative to said first bearing member and a source of pressure air for suspending said motors and said tray above said first bearing member.

14. The conveyor system set forth in claim 13 including:
a third air bearing member disposed for at least partially supporting said tray with respect to said second bearing member.

15. A reciprocating conveyor system for conveying one of material and articles generally linearly along a conveyor path, said conveyor system comprising:
an elongated conveyor tray including a support surface for said one of said material and articles;
support means for said tray for permitting linear reciprocating motion of said tray to convey said one of said articles and material along said tray toward a discharge end of said tray;
a linear motor aligned with and operably connected to said tray for imposing reciprocating linear motion of said tray;
support means for said motor allowing substantially linear displacement of said motor in a direction related to the direction of movement of said tray; and
a control system operably connected to said motor for effecting movement of said tray at a rate of acceleration in one direction which minimize slippage between said one of said material and articles and said tray while causing acceleration of said tray in another direction which will effect slippage of said one of said material and articles with respect to said tray.

16. The conveyor system set forth in claim 15 wherein:
said support means comprise respective linkages supporting said tray and said motor independently and allowing for linear reciprocating motion of said tray and said motor.

17. The conveyor system set forth in claim 16 wherein:
the mass of said motor and motor supporting components of said linkage is in a range of about 1.0 to 10.0 times the mass of said tray.

18. The conveyor system set forth in claim 15 wherein:
said motor comprises a linear electric motor including an armature operably connected to said tray and a stator mounted on said support means for said motor.

19. The conveyor system set forth in claim 15 wherein:
said control system is operable to impose a current on said motor to effect reciprocating motion of said armature and said tray at a predetermined rate of acceleration in one direction and at another predetermined rate of acceleration in an opposite direction of movement of said tray to effect conveyance of said one of said material and articles with said tray in said one direction and to provide slippage of said tray with respect to said one of said material and articles in said opposite direction.

20. The conveyor system set forth in claim 15 wherein:
said support means for said tray comprises an air bearing including a bearing member supporting said tray and a source of pressure air for causing said tray to be suspended relative to said bearing member on a layer of pressure air.

21. The conveyor system set forth in claim 15 wherein:
said support means comprises an air bearing system including a first air bearing member, and a second air bearing member for supporting said motor and said tray relative to said first bearing member and a source of pressure air for suspending said motor and said tray above said first bearing member.

22. The conveyor system set forth in claim 21 including:
a third air bearing member disposed for at least partially supporting said tray with respect to said second air bearing member.

23. A method for controlling a reciprocating conveyor system for conveying one of material and articles generally linearly along a conveyor path, said conveyor system comprising an elongated tray including a support surface for said one of said material and articles, a linear electrical motor operably connected to said tray for imposing reciprocating linear motion of said tray and support means for said motor and said tray for permitting linear reciprocating motion to convey said one of said articles and material along said tray toward a discharge end thereof, said method comprising:
imposing an electrical signal on said motor for effecting movement of said tray at a rate of acceleration in one direction which minimizes slippage between said one of said material and articles and said tray and imposing another electrical signal on said motor which causes acceleration of said tray in another direction and which will effect slippage of said one of said material and articles with respect to said tray to convey said one of said material and articles along said tray toward said discharge end.

24. The method set forth in claim 23 wherein:
said electrical signals comprise an electric current imposed on said motor and said method includes the steps of applying and increasing current to said motor during a first period of time to accelerate said tray without causing slippage of said one of said material and articles relative to said tray, increasing current applied to said motor during a further period of time to further accelerate said tray and said one of said material and articles without slippage of said one of said material and articles relative to said tray and applying a further current of opposite polarity during a third period of time to effect movement of said tray in an opposite direction and slippage of said one of said material and articles relative to said tray to effect movement of said one of said material and articles along said tray toward a discharge end.

25. The method set forth in claim 24 including the step of:
applying a substantially constant or decreasing current to said motor during a fourth period of time between said first period of time and said second period of time.

26. The method set forth in claim 23 including the step of:
applying said electrical signals to said motor at a rate which will impose reciprocating motion of said tray in a range of about 100 cycles per minute to 300 cycles per minute.

27. The method set forth in claim 26 including the step of:
providing the mass of said motor and support means therefor to be in a range of about 1.0:1.0 to 2.0:1.0 of the mass of said tray.
